(19) United States
(12) Patent Application Publication
(10) Pub. No.: US 2012/0060122 A1
(43) Pub. Date: Mar. 8, 2012

(54) DOCUMENT DISTRIBUTION SYSTEM, IMAGE FORMING DEVICE, DOCUMENT DATA CONTROLLING METHOD, AND RECORDING MEDIUM

(75) Inventor: Kensuke TANAKA, Kanagawa (JP)

(73) Assignee: RICOH COMPANY, LTD., Tokyo (JP)

(21) Appl. No.: 13/214,299

(22) Filed: Aug. 22, 2011

(30) Foreign Application Priority Data
Sep. 7, 2010 (JP) 2010-199969
Jun. 27, 2011 (JP) 2011-141398

(51) Int. Cl. G06F 3/048

(52) U.S. Cl. 715/825

(57) ABSTRACT

In a document distribution system, a storage unit stores distribution destination setup information including a filtering setup item for filtering document data and a process setup item indicating processes permitted on a distribution destination device. A distribution unit distributes document data based on distribution setup information. An acquisition unit acquires information of document data from a distribution destination device. A filtering unit filters the acquired document data based on the filtering setup item. A display control unit performs display control of a screen of screen data generated based on the process setup item of the distribution destination setup information and the information of the document data.

### BACKGROUND OF THE INVENTION

1. Field of the Invention

The present disclosure relates to a document distribution system, an image forming device, a document data controlling method, and a recording medium.

2. Description of the Related Art

In recent years, in many corporations, arrangement of image input/output devices, such as multi-function peripherals, and connection of the image input/output devices to a network is in progress. The image input/output devices bear a key role as a means for increasing the efficiency of business. Especially, the role of a document distribution system, which is arranged to generate electronic documents and images of paper documents and efficiently distribute the electronic documents and images, is important.

The key elements that constitute the document distribution system are an image input device (e.g., a scanner) and a document distributing device. In the document distributing device, a plurality of document data distribution processing menus which are prepared beforehand for various business tasks and uses are registered. A user selects a processing menu, which is appropriate for an individual business task, from among the registered processing menus on an operation panel of a scanner and performs scanning of a document by the scanner.

For example, Japanese Laid-Open Patent Publication No. 2006-018640 discloses a document distribution method in which plug-in applications of document distribution processing and image conversion processing are used, a user or administrator is urged to generate a distribution flow, including an input process, an image conversion process and an output process, by arbitrarily combining some of the plug-in applications, and perform document distribution processing of document data by using the generated distribution flow.

On the other hand, there is a document distribution system which is arranged to transmit a confirmation mail, in order to confirm that the document data has been distributed. For example, Japanese Laid-Open Patent Publication No. 2009-134613 discloses a document distribution system which is arranged to notify a user of a result of a document distribution process by transmitting an e-mail after a distribution process of document data is performed.

However, in the document distribution system according to the related art, the distribution result is notified to the user by the transmission of the e-mail only. In order for the user to check whether the document data has actually been distributed, it is necessary to receive the distribution result notice mail at the user's PC, or it is necessary to access a distribution destination device to which the document data is sent, and confirm the reception of the document data on the distribution destination device by himself. The user was not able to check the distribution result on the distribution source device. For this reason, if the document distribution processing had failed in the document distribution system, the user had to return back to the place of the image processing device and request the image processing device to perform again the document distribution processing. It has been difficult for the document distribution system according to the related art to meet the demands for increasing the efficiency of business.

### SUMMARY OF THE INVENTION

In one aspect, the present disclosure provides a document distribution system which is capable of confirming a distribution result of document data on a distribution source device of the document distribution system.

In an embodiment which solves or reduces one or more of the above-mentioned problems, the present disclosure provides a document distribution system including: a storage unit that stores distribution destination setup information which includes a filtering setup item for filtering document data to be displayed and a process setup item indicating processes permitted for execution on a distribution destination device; a distribution unit that distributes document data based on distribution setup information, the distribution setup information including position information indicating a distribution destination device; an acquisition unit that acquires information of document data from the distribution destination device indicated by the position information included in the distribution setup information, the document data information including the document data, a document name, and a data size; a filtering unit that filters the document data acquired by the acquisition unit, based on the filtering setup item of the distribution destination setup information; and a display control unit that performs display control of a screen of screen data generated based on both the process setup item of the distribution destination setup information and the information of the document data received from the filtering unit.

In an embodiment which solves or reduces one or more of the above-mentioned problems, the present disclosure provides an image forming device that controls distribution of document data, the image forming device including: a storage unit that stores distribution destination setup information which includes a filtering setup item for filtering document data to be displayed and a process setup item indicating processes permitted for execution on a distribution destination device; a distribution control unit that controls distribution of document data based on distribution setup information, the distribution setup information including position information indicating a distribution destination device; an acquisition unit that acquires information of document data from the distribution destination device indicated by the position information included in the distribution setup information, the document data information including the document data, a document name, and a data size; a filtering unit that filters the document data acquired by the acquisition unit, based on the filtering setup item of the distribution destination setup information; and a display control unit that performs display control of a screen of screen data generated based on both the process setup item of the distribution destination setup information and the information of the document data received from the filtering unit.

In an embodiment which solves or reduces one or more of the above-mentioned problems, the present disclosure provides a document data controlling method for use in an image forming device that controls distribution of document data and includes a storage unit that stores distribution destination setup information which includes a filtering setup item for filtering document data to be displayed and a process setup item indicating processes permitted for execution on a distribution destination device, the document data controlling method including: controlling, by a distribution control unit of the image forming device, distribution of document data based on distribution setup information, the distribution setup information including position information indicating a distribution destination device; acquiring, by an acquisition unit of the image forming device, information of document data from the distribution destination device indicated by the position information included in the distribution setup information, the document data information including the document data, a document name, and a data size; filtering, by a filtering unit of the image forming device, the document data acquired by the acquisition unit, based on the filtering setup item of the distribution destination setup information; and performing, by a display control unit of the image forming device, display control of a screen of screen data generated based on both the process setup item of the distribution destination setup information and the information of the document data received from the filtering unit.

Other objects, features and advantages of the present disclosure will be more apparent from the following detailed description when read in conjunction with the accompanying drawings.

### BRIEF DESCRIPTION OF THE DRAWINGS

FIG. 1 is a diagram showing an example of a document distribution system of a first embodiment of the present disclosure.

FIG. 2 is a block diagram showing the hardware composition of an MFP of the first embodiment.

FIG. 3 is a block diagram showing the hardware composition of a document distributing device of the first embodiment.

FIG. 4 is a block diagram showing the functional composition of the MFP of the first embodiment.

FIG. 5A and FIG. 5B are diagrams showing examples of distribution destination setup information.

FIG. 6 is a diagram showing an example of a data structure of distribution destination setup information.

FIG. 7 is a diagram showing an example of a display screen of distribution destination information.

FIG. 8 is a diagram showing an example of a display screen of distribution destination information.

FIG. 9 is a diagram showing an example of screen data of the display screen of distribution destination information.

FIG. 10 is a block diagram showing the functional composition of the document distributing device of the first embodiment.

FIG. 11 is a diagram showing an example of transition of screens.

FIG. 12 is a flowchart for explaining a distribution destination information display process of the first embodiment.

FIG. 13 is a flowchart for explaining a distribution destination information display process of the first embodiment.

FIG. 14 is a flowchart for explaining a distribution destination information display process of the first embodiment.

FIG. 15 is a flowchart for explaining an operation process of the first embodiment.

FIG. 16 is a block diagram showing the functional composition of an MFP of a second embodiment of the present disclosure.

FIG. 17 is a flowchart for explaining a distribution destination information display process of the second embodiment.

FIG. 18 is a flowchart for explaining an automatic notification process of the second embodiment.

### DETAILED DESCRIPTION OF THE PREFERRED EMBODIMENTS

A description will be given of embodiments of the present disclosure with reference to the accompanying drawings.

In the following embodiments, an MFP (multi-function peripheral) in which a printer function, a scanner function, a copier function and a facsimile function are incorporated in a single housing of the MFP, will be illustrated as an example of an image input device to input document data in a document distribution system of the present disclosure. Alternatively, a scanner device which is capable of inputting document data may be applicable as the image input device in the document distribution system of the present disclosure.

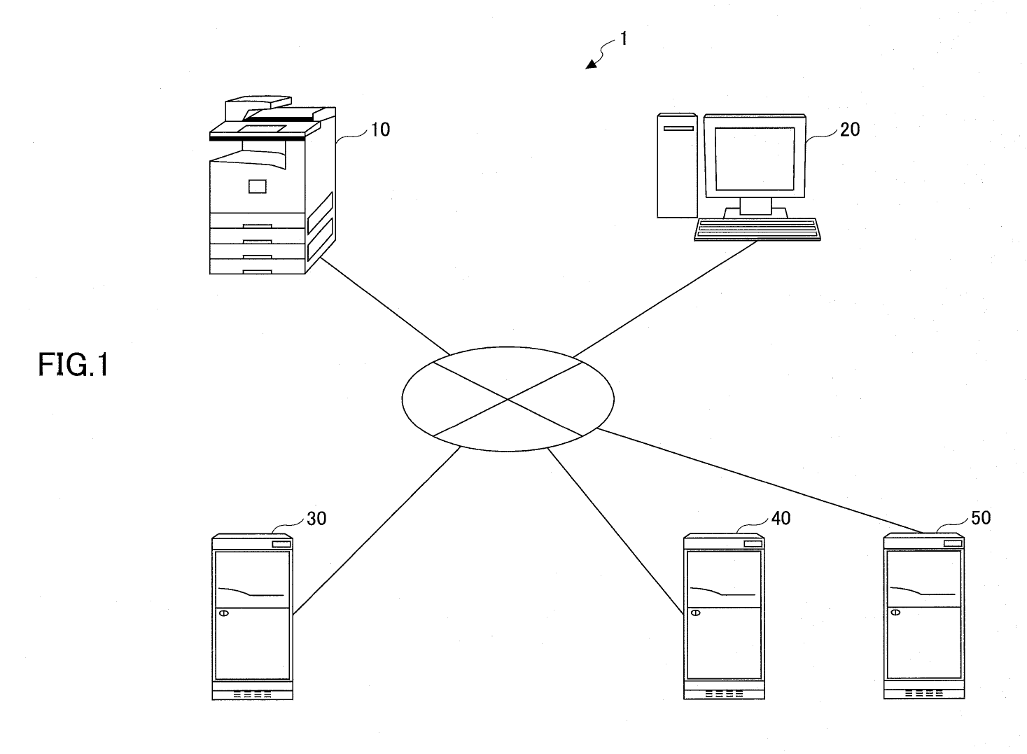

FIG. 1 is a diagram showing an example of a document distribution system of a first embodiment of the present disclosure. As shown in FIG. 1, the document distribution system 1 is constructed to include an MFP (multi-function peripheral) 10, an information processing terminal (e.g., a PC (personal computer), a PDA (personal data assistance), etc.) 20, a document distributing device (or a distributing server) 30, a document managing device 40, and a shared server 50, which are mutually connected via a network.

The MFP 10 is an image forming device that is arranged to include a scanner function, a copier function, a printer function, a facsimile function, etc. which are incorporated in a single housing of the MFP 10. The MFP 10 performs the scanning of paper documents and generates electronic document data by using the scanner function, and transmits the generated document data to the document distributing device 30 via the network. The details of the MFP will be described later. The generated document data contains electronic data of images of the paper documents.

In the information processing terminal 20, a data distribution related managing tool is started by an administrator. The plug-in applications of image conversion and output processes are sequentially selected by the administrator, and the information processing terminal 20 generates a distribution flow. The generated distribution flow is stored into the document distributing device 30. The information processing terminal 20 may be a distribution destination device of e-mail distribution.

The document distributing device 30 is a computer, such as a workstation, which receives the document data scanned and generated by the MFP, and performs various processes and document data distribution processes according to the designated distribution flow. The distribution flow may include an e-mail transmission, a facsimile transmission, a folder distribution, a MOSS distribution that distributes document data to a MOSS (Microsoft Office SharePoint Server), etc.

The document distributing device 30 may be a server which performs the distribution flow based on the input document data, and performs document data storage and distribution processes according to the distribution flow produced by the user. The details of the document distributing device 30 will be described later. Alternatively, the document distributing device 30 may be incorporated in the MFP 10.

The document managing device 40 manages the document data using folders or other items. The document managing device 40 manages the document data distributed from the document distributing device 30.

For example, the shared server 50 is a MOSS (Microsoft Office SharePoint Server). The shared server 50 manages the document data distributed from the document distributing device 30.

The number of MFPs, servers and information processing terminals which are mutually connected via the network may be arbitrary. The document distribution system 1 may include an e-mail distributing server. When the document distributing device 30 is incorporated in the MFP, the MFP may be arranged to generate a distribution flow.

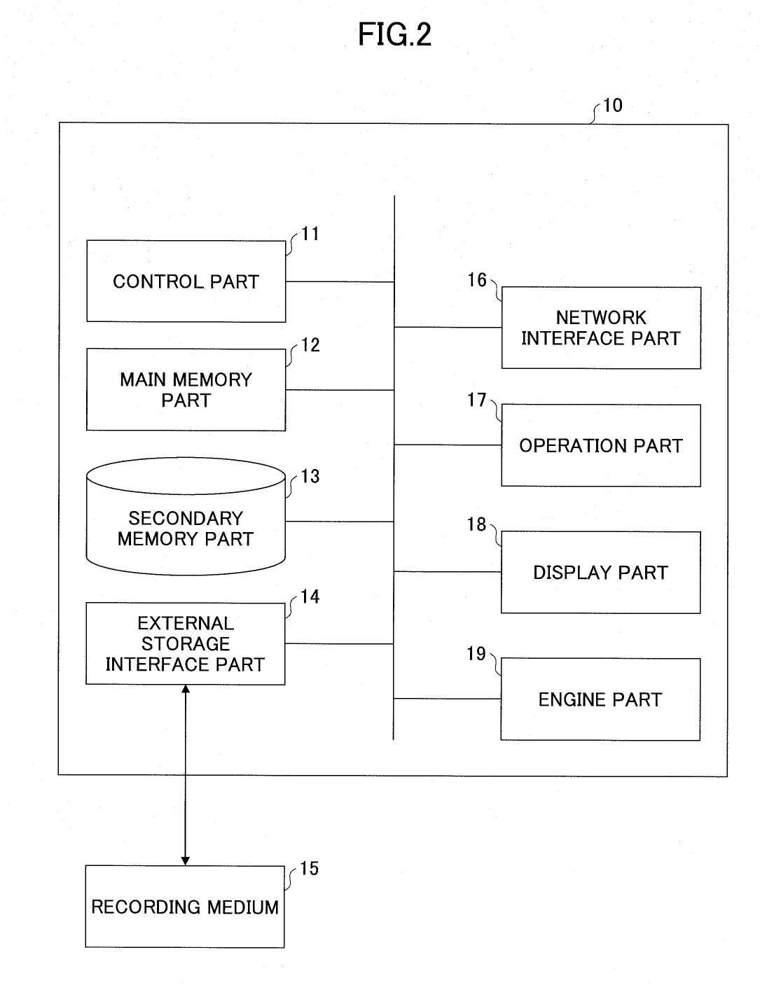

The hardware composition of the MFP 10 and the document distributing device 30 in the document distribution system of the first embodiment will be described. FIG. 2 is a block diagram showing the hardware composition of the MFP 10 of the first embodiment. As shown in FIG. 2, the MFP 10 is constructed to include a control part 11, a main memory part 12, a secondary memory part 13, an external storage interface part 14, a network interface part 16, an operation part 17, a display part 18, and an engine part 19. These elements of the MFP 10 are mutually connected via a bus, and transmission and reception of data between the elements of the MFP 10 can be performed via the bus.

The control part 11 is constituted by a CPU (central processing unit) of a microcomputer which controls component devices of the microcomputer and performs computation and processing of data. The control part 11 is a processing unit that executes the program stored in the main memory part 12, and the processing unit receives data from an input device or a storage device, and outputs the computed or processed data to an output device or a storage device.

The main memory part 12 is constituted by a ROM (read only memory), a RAM (random access memory), etc. In the main memory part 12, programs, including an OS (operating system) and application programs to be executed by the control part 11, and data are retained or temporarily stored.

The secondary memory part 13 is constituted by, for example, a HDD (hard disk drive). In the secondary memory part 13, data related to the application programs is stored.

The external storage interface part 14 is provided as an interface unit between the MFP 10 and a recording medium 15 (for example, a flash memory) which is connected to the MFP 10 via a data transmission line, such as a USB (universal serial bus). A predetermined program may be stored in the recording medium 15, and the predetermined program from the recording medium 15 may be installed in the MFP 10 via the external storage interface part 14. The installed program may be executed in the MFP 10.

The network interface part 16 is constituted by an interface unit between the MFP 10 and a peripheral device having a communication function and connected to the MFP 10 via a network, such as a WAN (wide area network) or a LAN (local area network), which is constructed with wired or wireless data transmission lines.

The operation part 17 is constituted by a set of key switches (hard keys), and the display part 18 is constituted by a LCD (liquid crystal display) having a touch-panel function which includes a software key of GUI (graphical user interface). The operation part 17 and the display part 18 in combination function as a display/input unit which provides a UI (user interface) for a user when selecting any of the functions of the MFP 10.

The engine part 19 is constituted by a document data input/output device, and performs reading of document data by scanning paper documents, and performs printing of the document data on copy sheets. The engine part 19 may be provided to include a scanner engine, a search engine, etc.

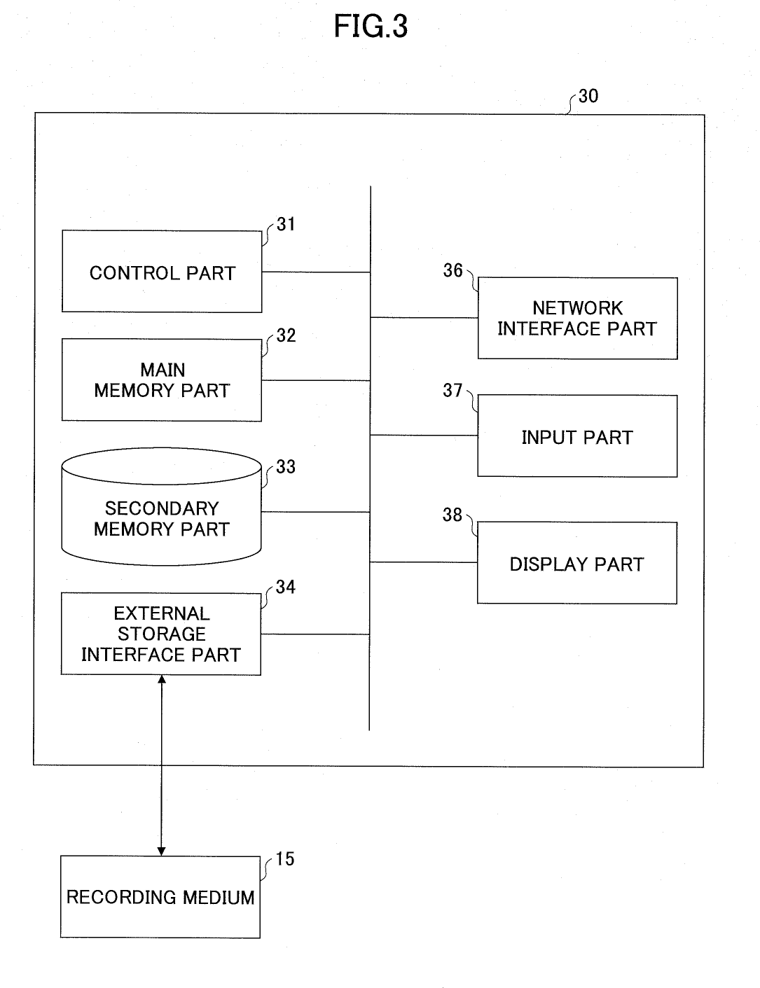

FIG. 3 is a block diagram showing the hardware composition of the document distributing device 30 of the first embodiment. As shown in FIG. 3, the document distributing device 30 is constructed to include a control part 31, a main memory part 32, a secondary memory part 33, an external storage interface part 34, a network interface part 36, an input unit 37, and a display part 38. These elements of the device 30 are mutually connected via a bus, and transmission and reception of data between the elements of the device 30 can be performed via the bus.

The control part 31 is constituted by a CPU of a microcomputer which controls component devices of the microcomputer and performs computation and processing of data. The control part 31 is a processing unit that executes the program stored in the main memory part 32, and the processing unit receives data from an input device or a storage device, and outputs the computed or processed data to an output device or a storage device.

The main memory part 32 is constituted by a ROM, a RAM, etc. In the main memory part 32, programs, including an OS and application programs to be executed by the control part 31, and data are retained or temporarily stored.

The secondary memory part 33 is constituted by, for example, a HDD. In the secondary memory part 33, data related to the application programs is stored.

The external storage interface part 34 is provided as an interface unit between the document distributing device 30 and a recording medium 15 (for example, a flash memory) which is connected to the device 30 via a data transmission line, such as a USB. A predetermined program may be stored in the recording medium 15, and the predetermined program from the recording medium 15 may be installed in the document distributing device 30 via the external storage interface part 34. The installed program may be executed in the document distributing device 30.

The network interface part 36 is constituted by an interface unit between the document distributing device 30 and a peripheral device having a communication function and connected to the device 30 via a network, such as a WAN or a LAN, which is constituted with wired or wireless data transmission lines.

The input part 37 is constituted by a keyboard and a mouse, etc. The keyboard is provided with cursor keys, numerical keys, function keys, etc., and the mouse is used to perform selection of a software key in a screen displayed on the display part 38. The input part 37 provides a UI (user interface) for a user when giving operational instructions or inputting data to the control part 31.

The display part 38 is constituted by a CRT, a LCD, etc. Display data output from the control part 31 is displayed on the display part 38.

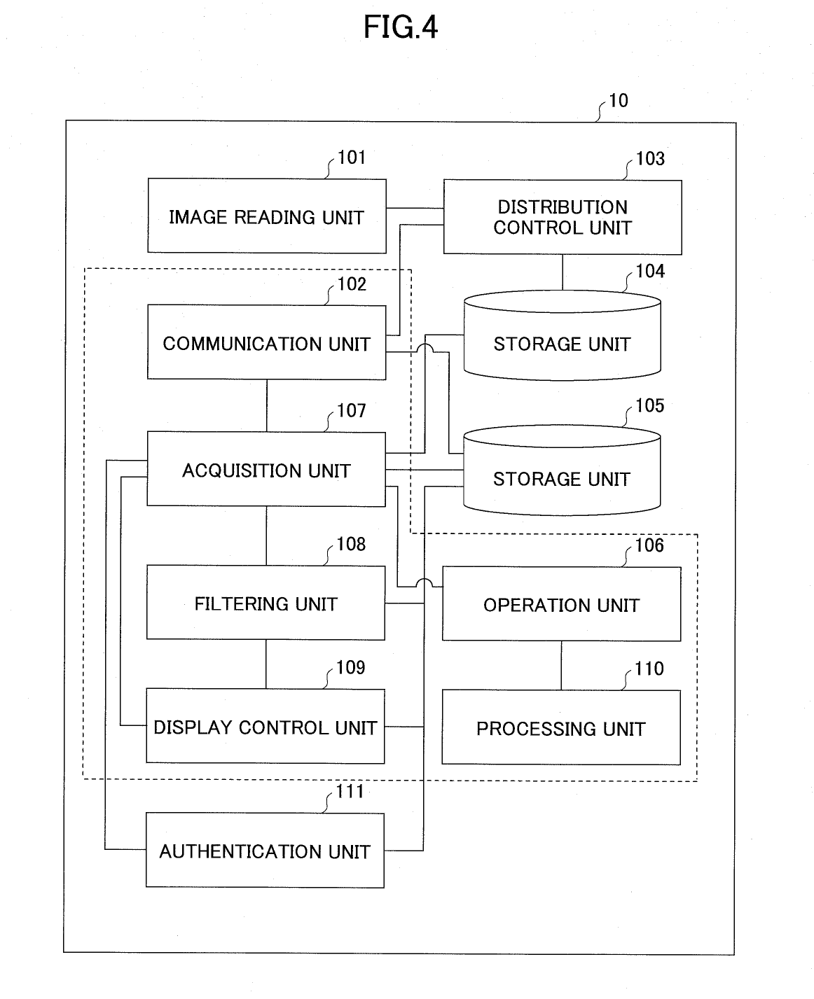

Next, the functions of the MFP 10 in the document distribution system of the first embodiment will be described. FIG. 4 is a block diagram showing the functional composition of the MFP 10 of the first embodiment. As shown in FIG. 4, the MFP 10 is constructed to include an image reading unit 101, a communication unit 102, a distribution control unit 103, a storage unit 104, a storage unit 105, an operation unit 106, an acquisition unit 107, a filtering unit 108, a display control unit 109, a processing unit 110, and an authentication unit 111. In FIG. 4, the illustration of a printer function, a copier function, a facsimile function, etc., which are usually provided in an MFP, is omitted.

The image reading unit 101 reads a document by using the scanner function, and acquires document data from the document. Alternatively, document data may be acquired by using the facsimile function, or may be received from the information processing terminal 20 via the network, or may be acquired from a hot folder on the network.

The communication unit 102 transmits device information, document data, etc. to an external device, or receives device information, document data, etc. from an external device. Especially, when a distribution flow processing request of document data is supplied by a user, the communication unit 102 transmits the document data and the processing request to the document distributing device 30. The communication unit 102 receives information of the document data from a distribution destination device to which the document data has been distributed.

The distribution control unit 103 receives a distribution flow designated by a user using the operation unit 106. The distribution flow to be selected by the user may be acquired from the storage unit 104.

Designation of a distribution flow may be performed by using the operation panel (the operation part 17 and the display part 18) of the MFP 10. At this time, bibliographic information of a process included in a distribution flow may be input by the user. In a case of an image conversion process, the bibliographic information thereof contains an image format, an image size, etc., and, in a case of an e-mail distribution process, the bibliographic information thereof contains a mail address of a distribution destination device.

The storage unit 104 stores each of plug-in applications of image conversion processing and output processing, and stores one or more distribution flows in which the processes of the relevant plug-in applications are combined. The storage unit 104 stores distribution setup information including position information of a distribution destination device. For example, the position information is an IP address of the distribution destination device.

According to the present disclosure, storing each plug-in application and each distribution flow in the storage unit 104 of the MFP 10 is not necessarily required. Alternatively, the MFP 10 may be arranged to acquire information of each distribution flow from a storage unit 306 of the document distributing device 30 via the network.

The storage unit 105 stores distribution destination setup information for every distribution destination device. The distribution destination setup information is acquired from the document distributing device 30 via the network. In the distribution destination setup information, data items for displaying the information of a distribution destination device are set up respectively. The data items in the distribution destination setup information include a filtering setup item for filtering document data, a setup item indicating whether to display distribution destination information, a setup item indicating a method of authentication, a setup item indicating an automatic notification of an end of distribution, and a process setup item indicating the processes permitted for execution. The “processes permitted” denote the processes that can be performed at the distribution destination device. Alternatively, the storage unit 104 and the storage unit 105 may be arranged in a single storage unit.

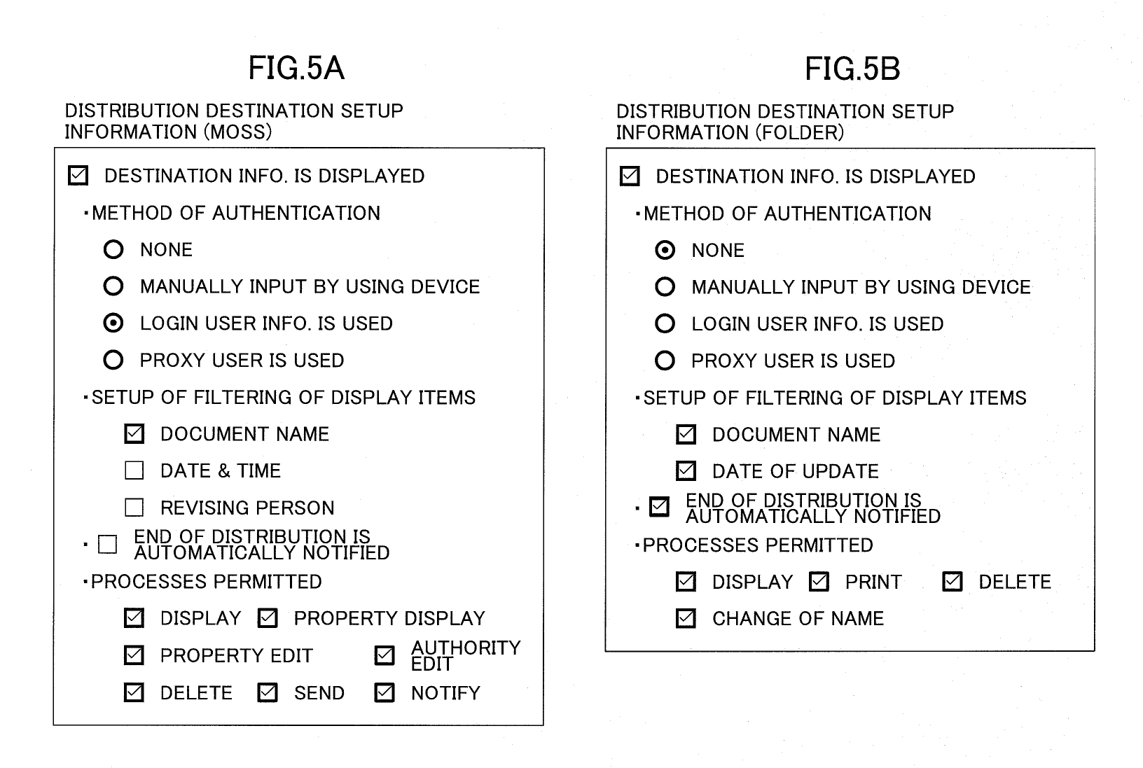

FIG. 5A and FIG. 5B are diagrams showing examples of distribution destination setup information. FIG. 5A shows an example of the distribution destination setup information in a case of MOSS distribution. In the example of FIG. 5A, the setup item is set up to display the distribution destination information, and the setup item for the authentication method is set up to use the login user information. Moreover, in the example of FIG. 5A, the filtering setup item is set to the document name, and the process setup item is set up to indicate that all the processes that can be operated by the MOSS are permitted.

FIG. 5B shows an example of the distribution destination setup information in a case of folder distribution. In the example of FIG. 5B, the setup item is set to display the distribution destination information, and when accessing the folder, the authentication is not performed. Moreover, in the example of FIG. 5B, the filtering setup item is set to the document name and the date of update, and the process setup item is set up to indicate that all the processes that can be operated to the document data within the folder are permitted.

The distribution destination setup information shown in FIG. 5A or FIG. 5B is set up by an administrator using the document distributing device 30. The set up item indicating the processes permitted as shown in FIG. 5A or FIG. 5B is set up for every distribution destination device to indicate the processes which can be operated at the distribution destination device concerned.

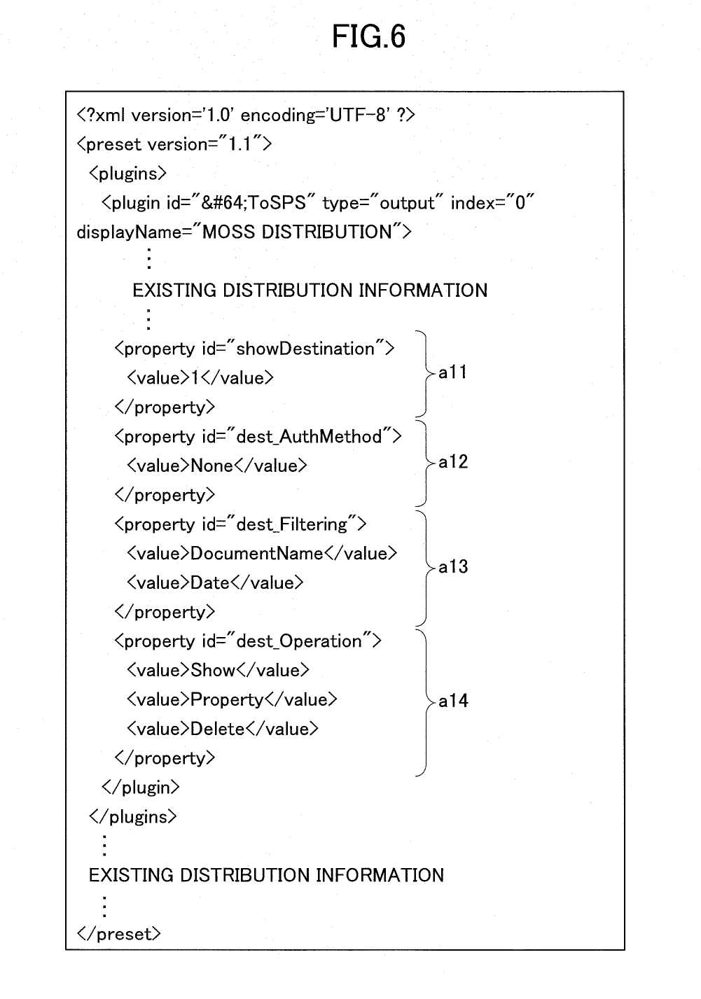

FIG. 6 is a diagram showing an example of a data structure of distribution destination setup information. In the example of FIG. 6, the “all” portion of the distribution destination setup information indicates whether to display the distribution destination information. For example, the value “0” indicates that the distribution destination information is not displayed, and the value “1” indicates that the distribution destination information is displayed.

In the example of FIG. 6, the “a12” portion indicates an authentication method required for accessing the distribution destination device. For example, the value “None” indicates that the authentication is not required, and the value “Manual” indicates that the authentication is performed by a manual input operation. The “a13” portion indicates the filtering setup item. For example, the value “DocumentName” indicates the document name, and the value “Date” indicates the date. The “a14” portion indicates the process setup item of the processes permitted for document data. For example, the value “Show” indicates displaying of the document data, the value “Property” indicates displaying of the property of the document data, and the value “Delete” indicates deletion of the document data.

The data of the distribution destination setup information as shown in FIG. 6 is stored in the storage unit 105.

Referring back to FIG. 4, the operation unit 106 in the MFP 10 receives a user's input operation on the operation panel or the hard keys. For example, the operation unit 106 receives a designation of a distribution flow, a confirmation of distribution destination information, and a request for execution of the processes to the distributed document data.

When a confirmation request is received from the operation unit 106, the acquisition unit 107 reads the distribution setup information and the distribution destination setup information, and accesses a distribution destination indicated by the position information included in the distribution setup information, by using the authentication method included in the distribution destination setup information. The acquisition unit 107 acquires the information of the document data from the distribution destination device indicated by the position information, through the communication unit 102. For example, the information of the document data acquired at this time contains the document data, a document name, a document size, an update date, etc.

The acquisition unit 107 outputs the acquired information of the document data to the filtering unit 108. When the filtering setup item included in the distribution destination setup information is not set up, the acquisition unit 107 outputs the acquired information of the document data to the display control unit 109.

When the distribution destination device is a MOSS, the acquisition unit 107 acquires the information of the document data by using the class library of WSS.0 Webservice API (see the URL: http://msdn.microsoft.com/ja-jp/library/cc768559.aspx). When the distribution destination device is a folder of the document managing device 40, the acquisition unit 107 acquires the information of the document data by using the SMB (server message block) protocol or the CIFS (common Internet file system). When the distribution destination device is a mail server, the acquisition unit 107 acquires the information of the document data by using POPS, IMAP, etc.

The filtering unit 108 filters the document data based on the filtering setup item included in the distribution destination setup information. For example, when filtering of the document data is performed by the document name, the filtering unit 108 filters only the document data having a predetermined document name. The information of the filtered document data is output from the filtering unit 108 to the display control unit 109. Other than the document name, the date/time and the revising person can also be set to the filtering setup item in the distribution destination setup information.

The display control unit 109 performs the display control of a screen of screen data generated based on the distribution destination setup information and the information of the document data acquired from the acquisition unit 107 or the filtering unit 108. The display control unit 109 generates the screen data so that the acquired information of the document data and the processes permitted which are indicated by the process setup item included in the distribution destination setup information may be displayed.

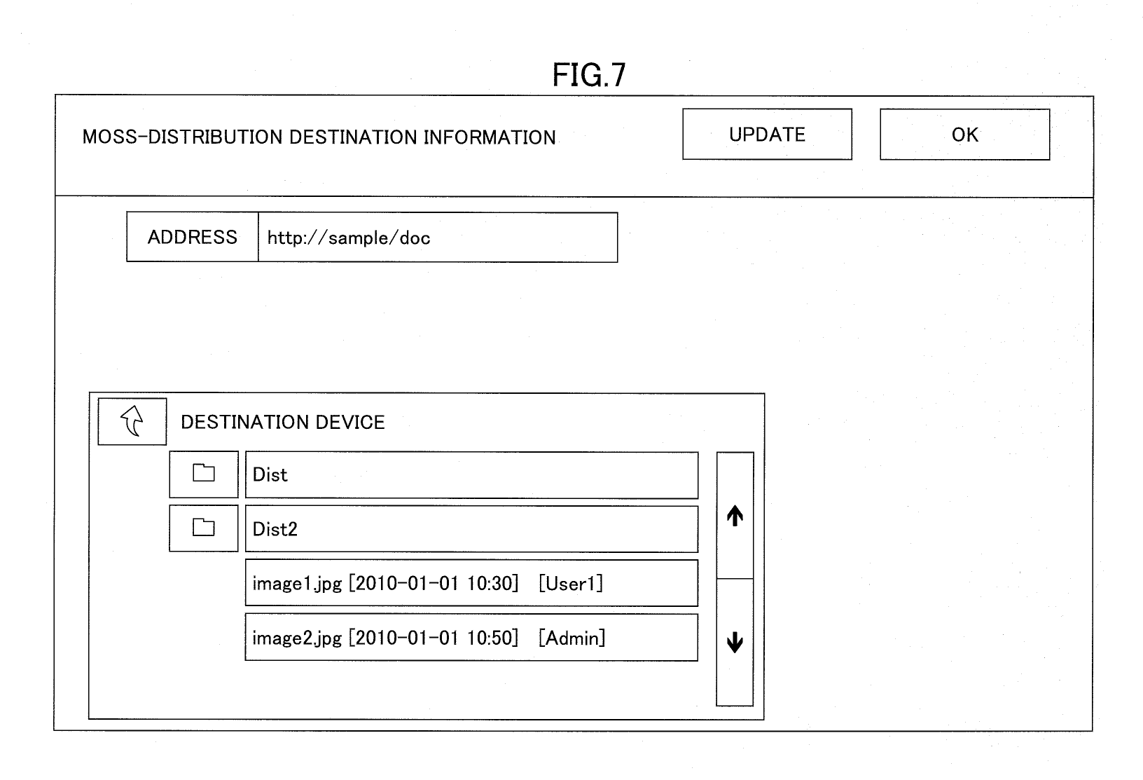

FIG. 7 is a diagram showing an example of a display screen of the distribution destination information. The display screen shown in FIG. 7 is a screen when there is no process permitted which is indicated by the distribution destination setup information. As shown in FIG. 7, a list of document data stored in a distribution destination device (which is a MOSS) is displayed.

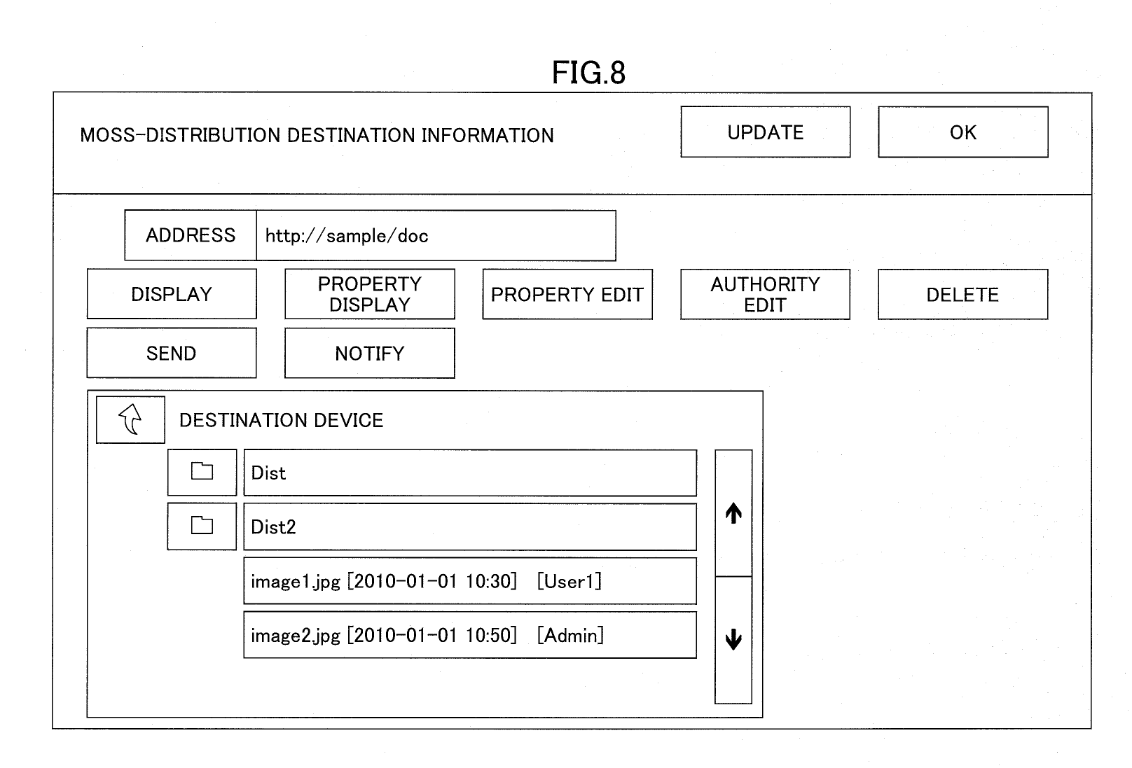

FIG. 8 is a diagram showing an example of a display screen of the distribution destination information. The display screen shown in FIG. 8 is a screen when there are processes permitted which are indicated by the distribution destination setup information. In the display screen shown in FIG. 8, the process buttons are additionally displayed when compared with the display screen shown in FIG. 7. The process buttons shown in FIG. 8 correspond to the boxes of the “processes permitted” in which the check marks are inserted by the user as shown in FIG. 5A.

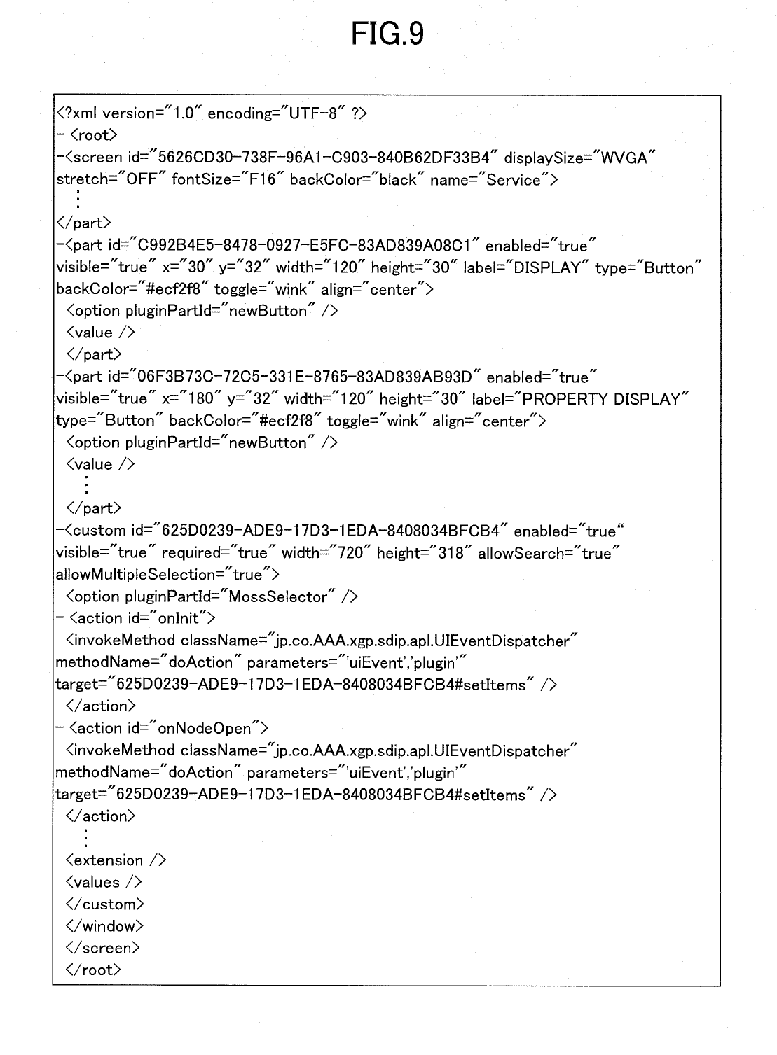

FIG. 9 is a diagram showing an example of screen data of the display screen of the distribution destination information. The display control unit 109 generates the screen data as shown in FIG. 9 based on the distribution destination setup information and the acquired information of the document data. When the display control unit 109 performs the display control of the screen data as shown in FIG. 9, the display screen as shown in FIG. 8 is displayed on the display part 18.

Referring back to FIG. 4, the processing unit 110 in the MFP 10 performs the processes when a request for execution of the “processes permitted” of the display screen is received from the operation unit 106. For example, the processes performed at this time include a display process, a property display process, a property editing process, an authority editing process, a delete process, a transmitting process, a notification process, a print process, a name changing process, etc. The processing unit 110 performs each process by using the API (application programming interface) currently published at the distribution destination device.

The authentication unit 111 performs authentication of a user who has logged in the MFP 10. When the setup item of the authentication method included in the distribution destination setup information is set up to indicate that “login user information is used”, the authentication unit 111 outputs authentication information of the login user to the acquisition unit 107. In this case, the acquisition unit 107 uses, when accessing the distribution destination device, the authentication information of the login user received from the authentication unit 111.

Among the functions of the communication unit 102, the operation unit 106, the acquisition unit 107, the filtering unit 108, the display control unit 109, and the processing unit 110 described above, the functions of reading the distribution destination setup information, acquiring the information of the document data from a distribution destination device, and displaying the distribution destination information may be separated and programmed into a document data control application.

The function of the image reading unit 101 is performed by using a scanner. For example, the functions of the distribution control unit 103, the acquisition unit 107, the filtering unit 108, the display control unit 109, the processing unit 110, and the authentication unit 111 are performed by the control part 11 and the main memory part 12 used as a work memory. For example, the function of the communication unit 102 is performed by the network interface part 16 which is controlled by the control part 11. For example, the function of the operation unit 106 is performed by the operation part 17, and the functions of the storage unit 104 and the storage unit 105 are performed by the secondary memory part 13 and/or the main memory part 12.

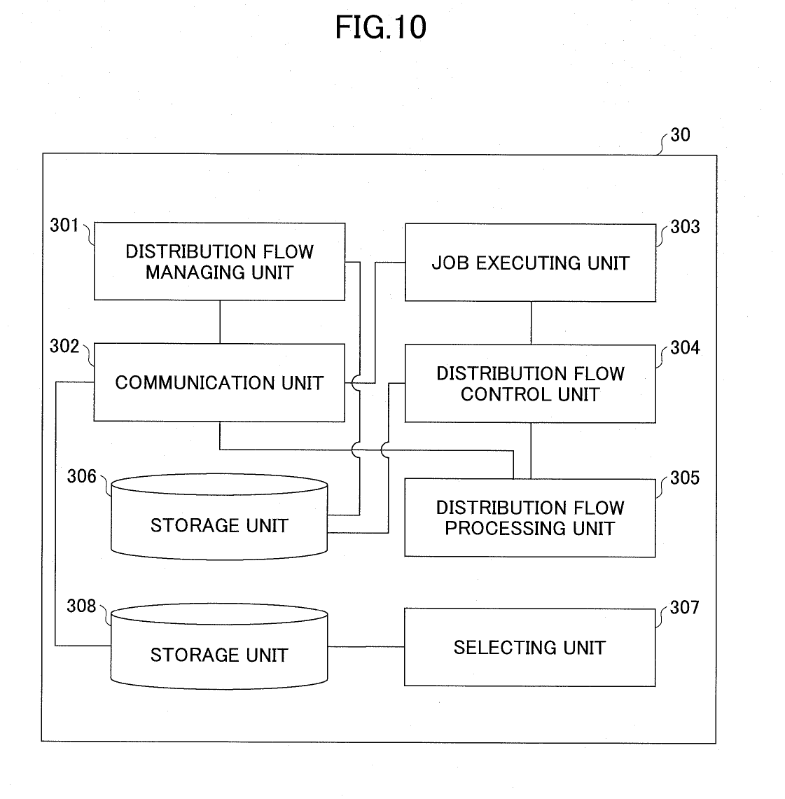

Next, the functions of the document distributing device 30 in the document distribution system of the first embodiment will be described. FIG. 10 is a block diagram showing the functional composition of the document distributing device 30 of the first embodiment. As shown in FIG. 10, the document distributing device 30 is constructed to include a distribution flow managing unit 301, a communication unit 302, a job executing unit 303, a distribution flow control unit 304, a distribution flow processing unit 305, a storage unit 306, a selecting unit 307, and a storage unit 308.

When a distribution flow in which respective plug-in applications of image conversion processing and output processing are combined arbitrarily is set up by a user, the distribution flow managing unit 301 stores the set-up distribution flow in an XML format into the storage unit 306. The distribution flow managing unit 301 controls a UI screen for setting up a distribution flow which is displayed on the information processing terminal 20. Moreover, the distribution flow managing unit 301 functions as a managing unit of the document distribution system 1.

The communication unit 302 transmits and receives device information, document data, etc. Especially, the communication unit 302 receives document data from the MFP 10, and transmits the document data obtained as a result of the image processing, to a distribution destination device of a distribution flow.

The communication unit 302 receives identification information of a distribution flow, bibliographic information of each of processes of a distribution flow, etc. from the MFP 10. When a processing request (job request) of a distribution flow is received from the MFP 10, the communication unit 302 outputs identification information of the distribution flow, bibliographic information of each of processes of the distribution flow, etc. to the job executing unit 303. The communication unit 302 transmits the distribution destination setup information stored in the storage unit 308 to the MFP 10.

The job executing unit 303 performs a job (for example, a print process) requested from the MFP 10. The job executing unit 303 sends a processing request of a distribution flow to the distribution flow control unit 304, and outputs identification information of a distribution flow, bibliographic information of each of processes of a distribution flow, and document data to the distribution flow control unit 304.

When a processing request of a distribution flow is received from the job executing unit 303, the distribution flow control unit 304 controls execution of each of the processes included in the distribution flow.

When a request of distribution flow control is received from the distribution flow control unit 304, the distribution flow processing unit 305 performs the distribution flow in accordance with the received request, and performs the document data distribution processing. Specifically, the distribution flow processing unit 305 performs each of the processes included in the distribution flow in a designated flow sequence, and distributes the document data to a distribution destination device.

The processes performed by the distribution flow processing unit 305 are divided into the image conversion processing and the output processing (or document data distribution processing). The image conversion processing is to convert an image format or size of document data, such as PDF conversion or TIFF conversion, or to perform an optical character recognition (OCR) process. The output processing is to distribute the acquired document data or the document data the image format of which is converted, to a distribution destination device (which may be an e-mail distributing server, an image managing server, etc.). It is supposed that at least the output processing is performed by the distribution flow processing unit 305.

The storage unit 306 stores each of the plug-in applications of the image conversion processing and the output processing, and stores one or more distribution flows in which the respective plug-in applications are combined.

The selecting unit 307 receives distribution destination setup information which is set up by an administrator. For example, as shown in FIG. 5A or FIG. 5B, the distribution destination setup information is set up by an administrator by inserting check marks in the boxes of the setup items. In addition to the existing distribution information according to the related art, the distribution destination setup information is transmitted from the selecting unit to the MFP 10 in synchronization with the MFP 10.

The storage unit 308 stores the distribution destination setup information received from the selecting unit 307. Alternatively, the storage unit 306 and the storage unit 308 may be configured into a single storage unit.

For example, the functions of the storage unit 306 and the storage unit 308 are performed by the secondary memory part 33 and/or the main memory part 32, and the function of the communication unit 302 is performed by the network interface part 36. The functions of other units of the document distributing device 30 are performed by the control part 31 and the main memory part 32 used as a work memory.

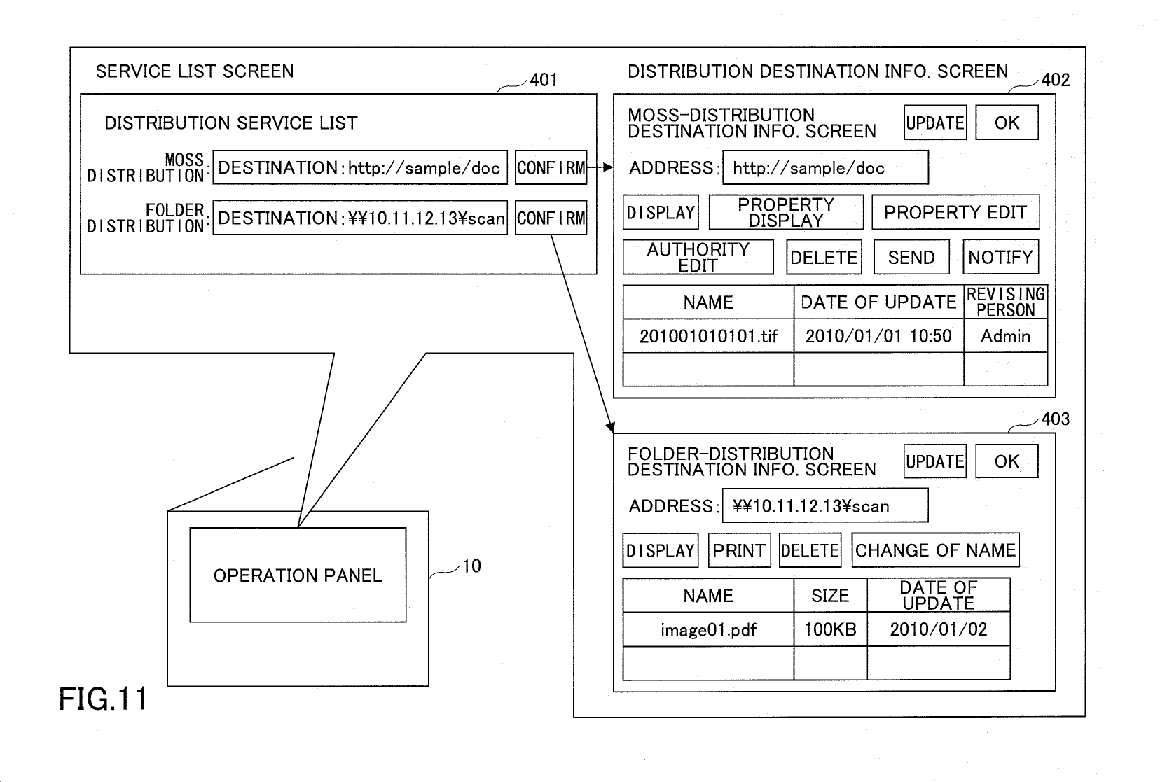

Next, an example of transition of display screens on the operation panel of the MFP 10 will be described. FIG. 11 is a diagram showing an example of transition of screens. In the example shown in FIG. 11, a distribution service list screen 401 changes to a distribution destination information screen 402 or 403. For example, when a confirmation button of MOSS distribution in the distribution service list screen 401 is pressed, the distribution destination information 402 of MOSS distribution is displayed.

The operation unit 106 detects the depression of a confirmation button and notifies the acquisition unit 107 of the detection. The acquisition unit 107 reads the distribution destination setup information stored in the storage unit 105 and the distribution setup information stored in the storage unit 104.

The acquisition unit 107 performs authentication of a user with respect to a distribution destination device indicated by the position information included in the distribution setup information, by using an authentication method indicated by the distribution destination setup information, and acquires the document data of the distribution destination device. When the filtering setup item in the distribution destination setup information is set up to perform filtering of document data, the filtering unit 108 is caused to perform filtering of the acquired document data and output the resulting document data to the display control unit 109.

The display control unit 109 generates screen data based on the “processes permitted” included in distribution destination setup information and the acquired document data. The display control unit 109 performs the display control of the generated screen data. Accordingly, the distribution destination information screen 402 is displayed on the operation panel. If a confirmation button of folder distribution in the screen 401 shown in FIG. 11 is pressed, the distribution destination information screen 403 of folder distribution will be displayed on the operation panel. The position information of the distribution destination device of the distribution service list screen is acquired from the distribution setup information.

Next, operation of the document distribution system 1 of the first embodiment will be described. The operation of the document distribution system 1 of the first embodiment differs depending on the contents of the distribution destination setup information, and respective descriptions thereof will be given separately.

### (1) Distribution Destination Information Display Process

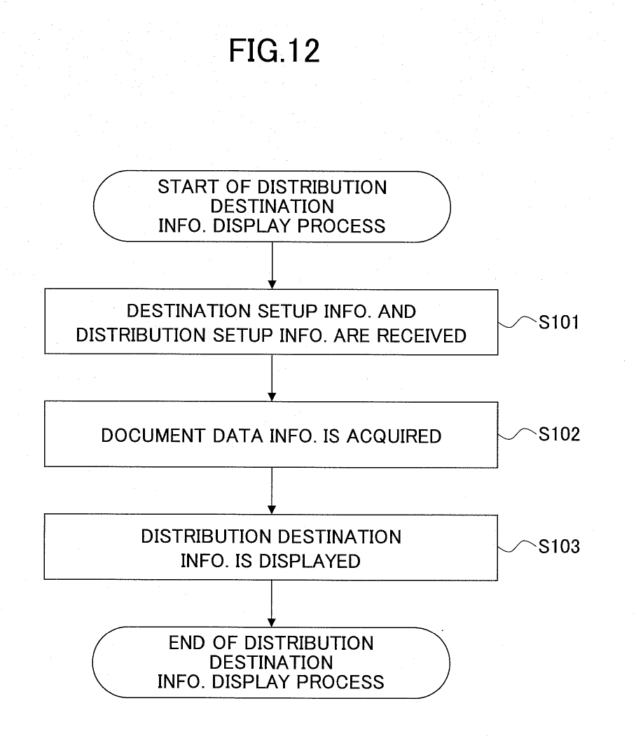

FIG. 12 is a flowchart for explaining a distribution destination information display process of the first embodiment. As shown in FIG. 12, if the operation unit 106 detects a displaying request of distribution destination information (depression of the confirmation button shown in FIG. 11), the acquisition unit 107 at step S101 reads the distribution destination setup information and the distribution setup information. It is assumed that at this time, the setup item for the authentication method is set up to indicate “none”.

At step S102, the acquisition unit 107 accesses a distribution destination device indicated by the position information of the distribution setup information, and acquires the information of the document data.

At step S103, the display control unit 109 generates screen data of the distribution destination information based on the acquired information of the document data and the process setup item of the distribution destination setup information indicating the processes permitted. The display control unit 109 performs the display control of the generated screen data. Accordingly, the display screen as shown in FIG. 7 or FIG. 8 is displayed on the operation panel of the MFP 10.

### (2) Distribution Destination Information Display Process Accompanied by Login

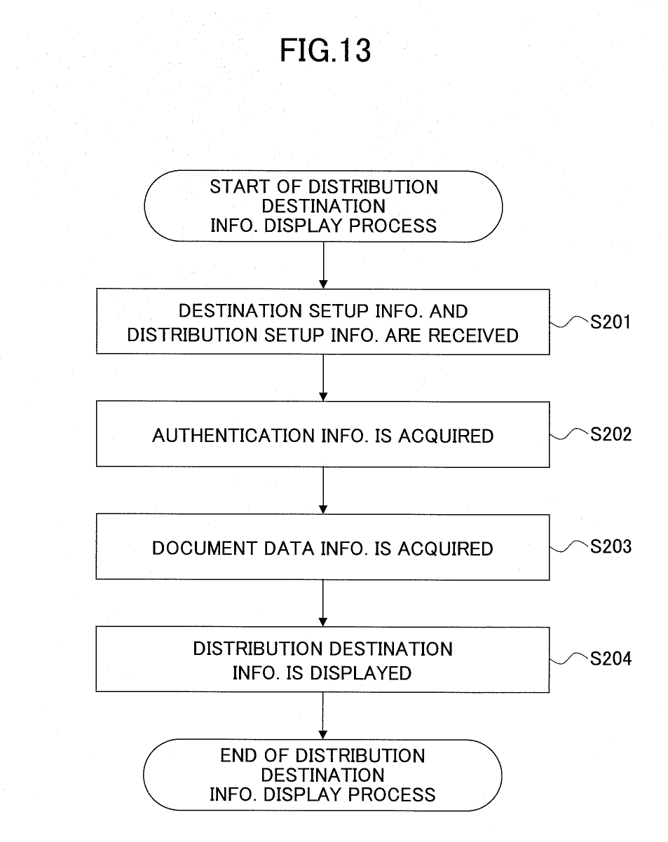

FIG. 13 is a flowchart for explaining a distribution destination information display process of the first embodiment. As shown in FIG. 13, if the operation unit 106 detects a display request of distribution destination information (depression of the confirmation button shown in FIG. 11), the acquisition unit 107 at step S201 reads the distribution destination setup information and the distribution setup information. It is assumed that at this time, the setup item for the authentication method is set up to indicate that “login user information is used”.

At step S202, the acquisition unit 107 acquires the login user information from the authentication unit 111. The login user information (authentication information) acquired at this time may contain a user ID and a password.

At step S203, the acquisition unit 107 accesses a distribution destination device indicated by the position information of the distribution setup information, by using the acquired authentication information, and acquires the information of the document data from the distribution destination device.

At step S204, the display control unit 109 generates screen data of the distribution destination information based on the acquired information of the document data and the process setup item of the distribution destination setup information indicating the processes permitted. The display control unit 109 performs the display control of the generated screen data. Accordingly, the display screen as shown in FIG. 7 or FIG. 8 is displayed on the operation panel of the MFP 10.

### (3) Distribution Destination Information Display Process Accompanied by Filtering

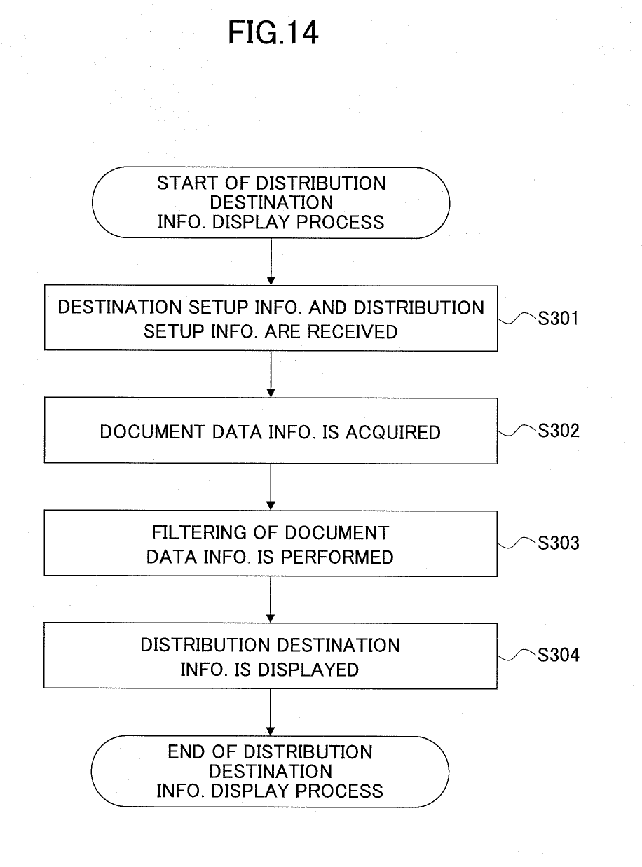

FIG. 14 is a flowchart for explaining a distribution destination information display process of the first embodiment. As shown in FIG. 14, if the operation unit 106 detects a display request of distribution destination information (depression of the confirmation button shown in FIG. 11), the acquisition unit 107 at step S301 reads the distribution destination setup information and the distribution setup information. It is assumed that at this time, the setup item for the authentication method is set up to indicate “none”.

At step S302, the acquisition unit 107 accesses a distribution destination device indicated by the position information of the distribution setup information, and acquires the information of the document data.

At step S303, the filtering unit 108 filters the document data acquired from the acquisition unit 107, based on the filtering setup item included in the distribution destination setup information. The filtered document data is output from the filtering unit 108 to the display control unit 109. For example, the filtering unit 108 filters the document data having a predetermined document name or a predetermined date based on the filtering setup item.

At step S304, the display control unit 109 generates screen data of the distribution destination information based on the acquired information of the document data and the process setup item of the distribution destination setup information indicating the processes permitted. The display control unit 109 performs the display control of the generated screen data. Accordingly, the display screen as shown in FIG. 7 or FIG. 8 is displayed on the operation panel of the MFP 10.

### (4) Operation Process

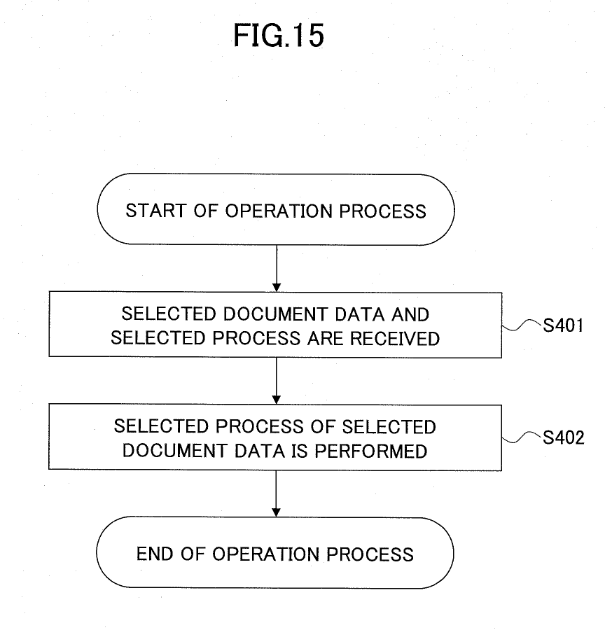

FIG. 15 is a flowchart for explaining an operation process of the first embodiment. The operation process shown in FIG. 15 is performed after the display screen of the distribution destination information is displayed as in the display processes of FIGS. 12-14. As shown in FIG. 15, at step S401, the operation unit 106 detects the selected document data as the object of the operation process and the selected process. The selected document data is the document data selected by the user from among various document data in the list of the distribution destination information screen. The selected process is the process selected by the user from among the respective processes displayed in the distribution destination information screen.

At step S402, the processing unit 110 performs the process selected by the user with respect to the selected document data. For example, when the selected process is a property display process, the property of the document data is displayed by using the API published at the distribution destination device. Accordingly, the selected process of the distributed document data can be performed on the distribution source device.

As described above, according to the document distribution system of the first embodiment, a distribution result of the distributed document data can be confirmed on the distribution source device. Moreover, a predetermined process of the distributed document data can be performed on the distribution source device.

Next, a second embodiment of the present disclosure will be described. In the second embodiment, a difference between information of document data of a distribution destination device before and after the distribution of the document data is determined, and the distribution destination information including the difference is displayed on a distribution source device.

The hardware composition of an MFP 10 of the second embodiment is essentially the same as that of the MFP 10 of the first embodiment, and a description thereof will be omitted.

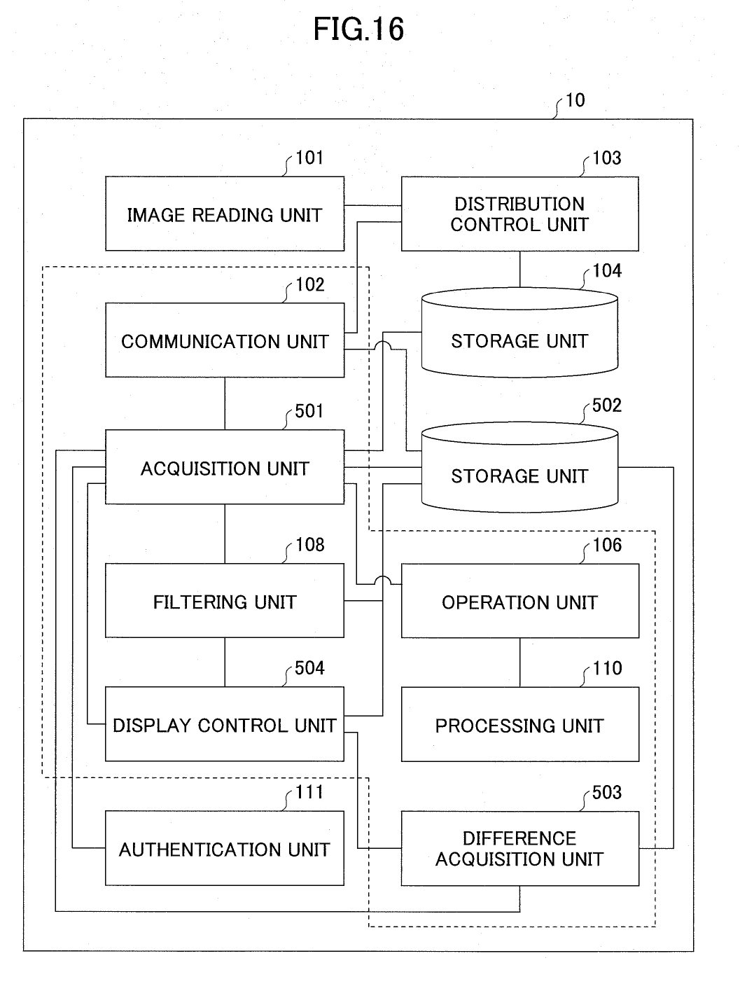

Next, the functions of the MFP 10 of the second embodiment will be described. FIG. 16 is a block diagram showing the functional composition of the MFP 10 of the second embodiment. In FIG. 16, the elements which are the same as corresponding elements in FIG. 4 are designated by the same reference numerals, and a description thereof will be omitted.

In the MFP 10 of FIG. 16, an acquisition unit 501 acquires information of document data from a distribution destination device indicated by the distribution setup information, before distribution of the document data to the distribution destination device is performed. The acquisition unit 501 stores the acquired information of the document data into a storage unit 502 as the information of the document data before the distribution.

After the document data is distributed to the distribution destination device, the acquisition unit 501 acquires the information of the document data from the distribution destination device in a manner similar to the previously described first embodiment. The acquired information of the document data after the distribution is output from the acquisition unit 501 to a difference acquisition unit 503. Other functions of the acquisition unit 501 of the second embodiment are essentially the same as those of the acquisition unit 107 of the first embodiment, and a description thereof will be omitted.

The storage unit 502 stores the document data information before the distribution. Moreover, the storage unit 502 stores the information previously described with respect to the first embodiment.

The difference acquisition unit 503 acquires the information of the document data after the distribution from the acquisition unit 501. Subsequently, the difference acquisition unit 503 acquires the information of the document data before the distribution from the storage unit 502. Subsequently, the difference acquisition unit 503 determines a difference between the acquired document data information before the distribution and the acquired document data information after the distribution. Finally, the difference acquisition unit 503 outputs the difference of the document data information to the display control unit 504.

The display control unit 504 generates screen data of distribution destination information including the difference of the document data information acquired from the difference acquisition unit 503. Hence, the possibility that the distribution destination information screen displayed in this case on the operation panel of the MFP 10 contains the distributed document data becomes high, and it is possible to easily confirm that the document data has been distributed appropriately.

The acquisition unit 501 may be arranged to acquire the information of the document data from the distribution destination device at a predetermined timing. The predetermined timing in this case means that such information is received from the distribution destination device periodically or at a time of power-on of the MFP 10. Each time the acquisition unit 501 acquires the information of the document data, the acquisition unit 501 stores the acquired information in the storage unit 502.

In the second embodiment, the difference acquisition unit 503 acquires the difference of the document data information each time the information of the document data is acquired. When a difference of the document data information exists, the difference acquisition unit 503 outputs the difference to the display control unit 504.

When the difference of the document data information is received from the difference acquisition unit 503, the display control unit 504 generates the screen data for displaying the received information, to notify the user of the received information (the difference). Accordingly, when a change arises in the document data of the distribution destination device, the user can be notified of the change in the document data.

For example, the function of the difference acquisition unit 503 is performed by the control part 11 and the main memory part 12 used as a work memory.

Next, operation of the document distribution system 1 of the second embodiment will be described.

### (5) Distribution Destination Information Display Process

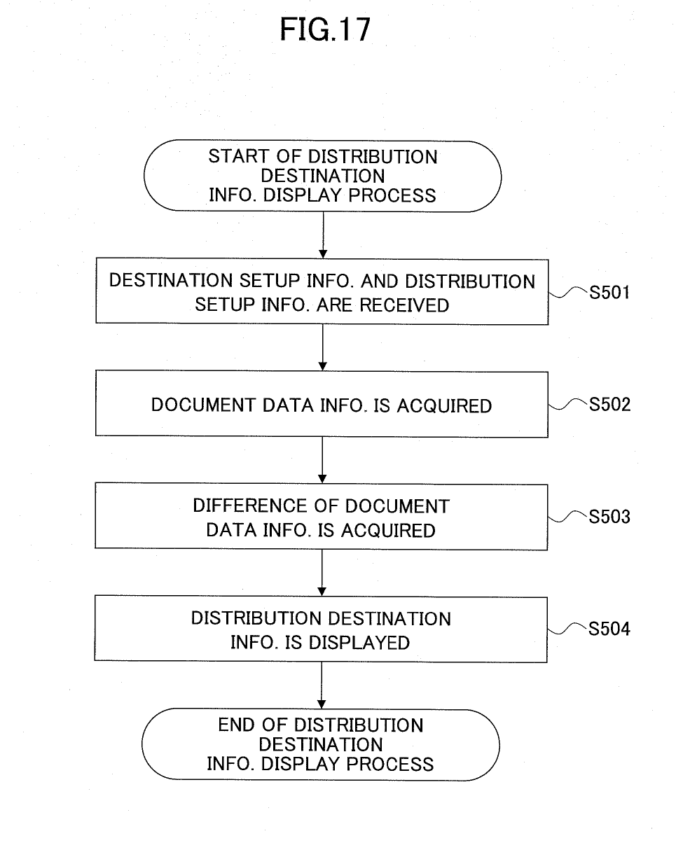

FIG. 17 is a flowchart for explaining a distribution destination information display process of the second embodiment. As shown in FIG. 17, if the operation unit 106 detects a displaying request of distribution destination information (depression of the confirmation button shown in FIG. 11), the acquisition unit 501 at step S501 reads the distribution destination setup information and the distribution setup information. It is assumed that at this time, the setup item for the authentication method is set up to indicate “none”.

At step S502, the acquisition unit 501 accesses a distribution destination device indicated by the position information of the distribution setup information, and acquires the information of the document data.

At step S503, the difference acquisition unit 503 determines the difference of the document data information in the distribution destination device before and after the distribution of the document data, and acquires the information of the document data contained in the difference. At this time, it is supposed that the information of the document data before the distribution is already stored in the storage unit 502.

At step S504, the display control unit 504 generates the screen data of the distribution destination information based on the difference of the document data information and the process setup item of the distribution destination setup information indicating the processes permitted. The display control unit 504 performs display control of a distribution destination information screen of the generated screen data.

### (6) Automatic Notification Process

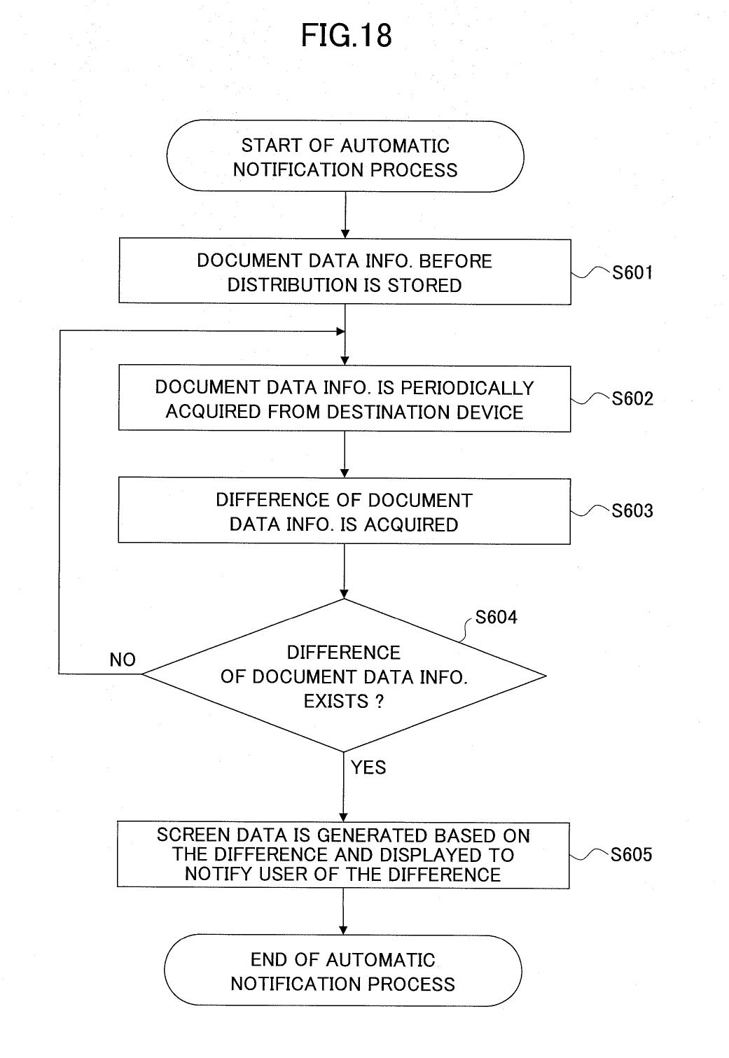

FIG. 18 is a flowchart for explaining an automatic notification process of the second embodiment. As shown in FIG. 18, the acquisition unit 501 at step S601 acquires, before the document data is distributed, the information of the document data from the distribution destination device indicated by the distribution setup information. The acquired document data information before the distribution is stored in the storage unit 502.

At step S602, the acquisition unit 501 acquires the information of the document data from the distribution destination device at a predetermined timing.

At step S603, the difference acquisition unit 503 acquires a difference between the acquired document data information after the distribution and the stored document data information before the distribution.

At step S604, the difference acquisition unit 503 determines whether a difference of the document data information exists, based on the acquired difference at step S603. When it is determined at step S604 that a difference exists, the control progresses to step S605. When it is determined at step S604 that no difference exists, the control is returned to step S602. The step S602 will be performed at the predetermined timing.

At step S605, the display control unit 504 generates screen data of distribution destination information based on the difference acquired from the difference acquisition unit 503, and displays a screen of the screen data on the display part 18, to notify the user that the difference of the document data information arises.

As described above, according to the second embodiment, a difference of document data information before and after distribution of document data is determined, a distribution destination information screen including the difference is displayed on a distribution source device, and it is possible to easily confirm the distributed document data. The information of the document data is periodically acquired from the distribution destination device, and the notification of document data distribution to the user may be performed only when a difference arises.

Next, a modification of the MFP in the document distribution system of the present disclosure will be described. In this modification, the previously described document distributing device is incorporated in the MFP. The hardware composition of the MFP of this modification is essentially the same as that of the previously described first embodiment, and a description thereof will be omitted.

The respective functions of the MFP of this modification in which the document distributing device is incorporated are essentially the same as the functions of the MFP shown in FIG. 4 or FIG. 16 and the functions of the document distributing device shown in FIG. 10, and a description thereof will be omitted. Hence, the illustrated processes of the first embodiment can be carried out by the MFP of this modification only.

The program executed by the MFP of the first embodiment, the second embodiment or the modification of the present disclosure may be stored in an installable or executable form in a computer-readable recording medium, such as a CD-ROM, a FD (flexible disk), a CD-R, a DVD (digital versatile disk), etc., and the recording medium storing the program therein may be offered.

Alternatively, the program executed by the MFP of the first embodiment, the second embodiment or the modification of the present disclosure may be stored on a computer connected to a network, such as the Internet, and it may be offered by downloading the program via the network. Alternatively, the program executed by the MFP of the first embodiment, the second embodiment or the modification of the present disclosure may be offered or distributed via a network, such as the Internet.

Alternatively, the program executed by the MFP of the first embodiment, the second embodiment or the modification of the present disclosure may be beforehand stored in a ROM, and the ROM storing the program therein may be offered.

The program executed by the MFP of the first embodiment, the second embodiment or the modification of the present disclosure is configured into a set of modules including the respective units of the MFP described above, and, when executed by a CPU (processor) of the MFP, one or more modules of the program are read from the secondary memory part of the MFP and loaded on the main memory part of the MFP, and the one or more modules of the program cause the CPU to execute any of the illustrated processes of the foregoing embodiments of the present disclosure.

As described in the foregoing, according to the present disclosure, it is possible to provide a document distribution system which is capable of confirming the distribution result of document data on the distribution source device of the document distribution system.

The present disclosure is not limited to the specifically disclosed embodiments, and variations and modifications may be made without departing from the scope of the present disclosure.

The present application is based upon and claims the benefit of priority of Japanese patent application No. 2010-199969, filed on Sep. 7, 2010, and Japanese patent application No. 2011-141398, filed on Jun. 27, 2011, the contents of which are incorporated herein by reference in their entirety.

What is claimed is:

1. A document distribution system that distributes document data, comprising:
a storage unit that stores distribution destination setup information which includes a filtering setup item for filtering document data to be displayed and a process setup item indicating processes permitted for execution on a distribution destination device;
a distribution unit that distributes document data based on distribution setup information, the distribution setup information including position information indicating a distribution destination device;
an acquisition unit that acquires information of document data from the distribution destination device indicated by the position information included in the distribution setup information, the document data information including the document data, a document name, and a data size;
a filtering unit that filters the document data acquired by the acquisition unit, based on the filtering setup item of the distribution destination setup information; and
a display control unit that performs display control of a screen of screen data generated based on both the process setup item of the distribution destination setup information and the information of the document data received from the filtering unit.

2. The document distribution system according to claim 1, further comprising an authentication unit that performs authentication of a user, wherein the acquisition unit is arranged to use, when accessing the distribution destination device, user authentication information received from the authentication unit.

3. The document distribution system according to claim 1, wherein the acquisition unit comprises a difference acquisition unit that acquires first information of the document data from the distribution destination before distribution of the document data, acquires second information of the document data from the distribution destination device after the distribution of the document data, and determines a difference between the first information and the second information, and
the display control unit is arranged to generate screen data of distribution destination information including the difference of the document data information received from the difference acquisition unit.

4. The document distribution system according to claim 3, wherein the acquisition unit is arranged to acquire the document data information from the distribution destination device at a predetermined timing, and the difference acquisition unit is arranged to acquire a difference between the currently acquired document data information and the previously acquired document data information each time the document data information is acquired by the acquisition unit.

5. An image forming device that controls distribution of document data, comprising:
a storage unit that stores distribution destination setup information which includes a filtering setup item for filtering document data to be displayed and a process setup item indicating processes permitted for execution on a distribution destination device;
a distribution control unit that controls distribution of document data based on distribution setup information, the distribution setup information including position information indicating a distribution destination device;
an acquisition unit that acquires information of document data from the distribution destination device indicated by the position information included in the distribution setup information, the document data information including the document data, a document name, and a data size;
a filtering unit that filters the document data acquired by the acquisition unit, based on the filtering setup item of the distribution destination setup information; and
a display control unit that performs display control of a screen of screen data generated based on both the process setup item of the distribution destination setup information and the information of the document data received from the filtering unit.

6. The image forming device according to claim 5, further comprising an authentication unit that performs authentication of a user, wherein the acquisition unit is arranged to use, when accessing the distribution destination device, user authentication information received from the authentication unit.

7. The image forming device according to claim 5, wherein the acquisition unit comprises a difference acquisition unit that acquires first information of the document data from the distribution destination device before distribution of the document data, acquires second information of the document data from the distribution destination device after the distribution of the document data, and determines a difference between the first information and the second information, and
the display control unit is arranged to generate screen data of distribution destination information including the difference of the document data information received from the difference acquisition unit.

8. The image forming device according to claim 7, wherein the acquisition unit is arranged to acquire the document data information from the distribution destination device at a predetermined timing, and the difference acquisition unit is arranged to acquire a difference between the currently acquired document data information and the previously acquired document data information each time the document data information is acquired by the acquisition unit.

9. A document data controlling method for use in an image forming device that controls distribution of document data and includes a storage unit that stores distribution destination setup information which includes a filtering setup item for filtering document data to be displayed and a process setup item indicating processes permitted for execution on a distribution destination device, the document data controlling method comprising:
controlling, by a distribution control unit of the image forming device, distribution of document data based on distribution setup information, the distribution setup information including position information indicating a distribution destination device;
acquiring, by an acquisition unit of the image forming device, information of document data from the distribution destination device indicated by the position information included in the distribution setup information, the document data information including the document data, a document name, and a data size;
filtering, by a filtering unit of the image forming device, the document data acquired by the acquisition unit, based on the filtering setup item of the distribution destination setup information; and
performing, by a display control unit of the image forming device, display control of a screen of screen data generated based on both the process setup item of the distribution destination setup information and the information of the document data received from the filtering unit.

10. A non-transitory computer-readable recording medium storing a program which, when executed by a computer, causes the computer to perform the document data controlling method according to claim 9.
